(19) United States
(12) Patent Application Publication
(10) Pub. No.: US 2005/0287283 A1
(43) Pub. Date: Dec. 29, 2005

(54) Mixed animal feed

(76) Inventor: Leon Milner Theodore Dicks, Stellenbosch (ZA)

Correspondence Address: AKERMAN SENTERFITT, P.O. BOX 3188, WEST PALM BEACH, FL, 33402-3188, US

(21) Appl. No.: 10/534,853

(22) PCT Filed: Nov. 13, 2003
(86) PCT No.: PCT/IB03/05126

§ 371 Date: May 13, 2005

(30) Foreign Application Priority Data
Nov. 14, 2002 (ZA) 2002/9250

(51) Int. Cl. A23K 1/00

(52) U.S. Cl. 426/635

(57) ABSTRACT

A mixed animal feed is provided comprising a conventional grass based feed admixed with up to 60% by weight of by-product seed optionally mixed with grape husks. The conventional grass based feed may include lucerne hay. Preferably, the grape seed and, where present, grape husks, have been pre-treated with at least one, and typically a combination of, tannin degrading bacteria that is or are conveniently tannin-hydrolysing lactic acid bacteria. The grape seed would typically be milled prior to contacting it with a suspension of bacteria followed by pelletising the treated grape seed and husks, where present.

### FIELD OF THE INVENTION

This invention relates to a mixed animal feed in which there is utilized an agricultural byproduct. More particularly, but not exclusively, the invention relates to an animal feed that is suitable for use in feeding sheep.

### BACKGROUND TO THE INVENTION

Wheat is the dominant forage available during summer in sheep farming areas that are subject to a Mediterranean climate, and of particular interest, in South Africa. Stubble, however, is reported to have low levels of nitrogen and available carbohydrates, a high cell wall content and poor digestibility (Dann and Coombe, 1987), rendering it unsuitable to meet the high nutrient requirements of producing sheep (Aitchinson, 1988). It is therefore commonplace to provide supplementary feeding especially for ewes grazing stubble to provide additional energy and protein (Aitchinson, 1998; Brand, 1997a). One common form of supplementary feed is lucerne hay.

Grapes are widely grown in the Mediterranean area, producing considerable quantities of by-products in the form of grape seeds and husks resulting from the fruit juice and wine producing industries. Traditionally, the grape seeds and husks are dumped or used as compost.

It has now surprisingly been found that a useful mixed animal feed can be produced using this agricultural by-product.

### OBJECT OF THE INVENTION

It is, accordingly, an object of the invention to provide a mixed animal feed that embodies a proportion of agricultural by-product material.

### SUMMARY OF THE INVENTION

In accordance with this invention there is provided a mixed animal feed comprising a conventional grass based feed admixed with at least one other animosity constituent, the mixed animal feed being characterised in that it comprises up to 60% by weight of by-product grape seed optionally mixed with grape husks.

Further features of the invention provide for the conventional grass based feed to be lucerne hay, typically in pelleted or other agglomerated form; for the grape seed and, where present, grape husks, to be pre-treated with at least one, and typically a combination of tannin degrading bacteria, preferably tannin-hydrolysing lactic acid bacteria; for the grape seeds and any grape husks admixed therewith to be dried, milled, typically in a hammer mill and pelleted for admixture with the conventional grass based feed; and for the milled by-product, in instances in which it is to be pre-treated with bacteria, to be suspended in a suspension that is inoculated with the bacteria prior to drying and pelletising.

Regarding suitable bacteria to be employed for the aforesaid purpose, a number of bacteria capable of degrading tannins have been identified, viz. Streptococcus bovis, Streptococcus caprinus and Streptococcus gallolyticus (Brooker et al., 1994; Ossawa et al., 1995; Sly et al., 1997). Many of the strains were isolated from the rumen of goats browsing on Acacia (rich in tannins). The strains were resistant to condensed tannins from Acacia anuera and grew in media containing concentrations as high as 2.5%, w/v (Brooker et al., 1994).

Despite the identification of diverse populations of tannin tolerant bacteria from a number of animals, e.g. goat (Brooker et al., 1994; McSweeny et al., 1996), koalas (Osawa, 1990; 1992; Osawa and Sly, 1992) and other ruminants (Nelson et al., 1995; Odenyo and Osuji, 1998), little is known about the relationships these organisms have with other (normal) gut microflora and the mechanisms they use to degrade tannins (Brooker, 2000).

The invention is therefore based on the fact that the basal diet of sheep, consisting of lucerne hay, can be altered by replacing various proportions, and up to about one half (50%) of the lucerne hay, with grape seeds and husks. The invention, in its preferred implementation is still further based on the fact that binding of tannins (from the grape seeds and husks) to proteins can be decreased by treating the grape seeds and husks beforehand with a combination of tannin-hydrolyzing lactic acid bacteria.

The invention therefore also provides a feed constituent comprising by-product grape seed optionally mixed with grape husks and wherein the grape seeds and any husks mixed therewith have been treated with a tannin degrading bacteria. The tannin degrading bacteria is preferably at least one and typically a mixture of tannin hydrolysing bacteria. The by-product grape seed and any husks mixed therewith are preferably milled and sized, typically to a size of about 1 mm in diameter prior to contacting with an aqueous culture of the relevant bacteria.

In order that the invention may be more fully understood an extended description thereof with reference to the drawings and the results of various investigations that have been carried out to date, now follow.

### BRIEF DESCRIPTION OF THE DRAWINGS

In the drawings:—

FIG. 1 is a bar chart illustrating the comparative activity of the tannin hydrolysing bacteria identified as TS1 TS2 TS3 and TS4 herein as compared to a control batch utilizing a control Lactobacillus sp. that could grow in the suspension and that tested slightly positive for tannin hydrolysis;

FIG. 2 is a set of four graphs illustrating the hydrolysis of tannins in a tannin rich medium in respect of each of the four bacteria identified as TS1 (FIG. 2A), TS2 (FIG. 2B), TS3 (FIG. 2C) and TS4 (FIG. 2D) individually; and,

FIG. 3 is a flow diagram illustrating a proposed treatment of grape pips and husks preparatory to forming the mixed feed.

### DETAILED DESCRIPTION OF VARIOUS ASPECTS OF THE INVENTION

A breakdown of the protein, fat and various fibre contents of the seeds, and a combination of husks and seeds, of a mixture of four red wine cultivars (Merlot, Shiraz, Carignan and Cabernet Sauvignon), is presented in Table 1 (see page 14). The amino acid composition of the latter is presented in Table 2 (see page 14). In each instance comparisons were made with plant products that are normally added to animal feed.

The overall chemical composition of grape pips and a combination of husks and pips was very similar (Table 1). The protein content of the husks and pips was lower than that recorded for Alfalfa (12.7% versus 15%). However, the fat content of the grape pips was much higher compared to Alfalfa (10.3 and 7.9% versus 1.6%). The higher fat content would result in an increase in energy production and is, in the light of this, considered to be an advantage. The higher ADF (acid detergent fiber) and NDF (neutral detergent fiber) contents recorded in grape pips and husks would, however, slow down the enzymatic conversion of the animal feed in the gut and is thus considered to be a disadvantage. The total DM (dry matter) is also set out in Table 1.

The grape seeds contained a larger variety of amino acids than was recorded for maize and soya (Table 2), rendering it a more suitable animal feed. However, Lysine, a limiting and very important amino acid in animal feed, is present at very low concentrations (0.387%). This indicated that a mixed feed could work effectively.

Tannins are not easily degradable. Metabolic energy in animal feed is derived mostly from starches, sugars, carbohydrates, fats and oils. Binding of tannins to any of the latter substrates is believed to restrict the digestibility of the substrate (Tangendjaja, 2000), which in turn may lead to a lowering in the digestibility of the substrates in an animal feed. Furthermore, binding of tannins to proteins is believed to the produce insoluble or soluble tannin-protein (and also tannin-enzyme) complexes which, when ingested, may lead to a lowering of enzyme activity, followed by a decrease in intestinal metabolic activity which may lead to malnutrition.

Tannins occur in red grapes, and are present either in hydrolysable or condensed forms (Butler, 1989). There is an inverse relationship between high tannin level in forage and palatability, digestibility and voluntary intake. Grape seeds (pips), -husks and -skins are rich in condensed tannin content (approximately 14 g STE, sorghum Tannin Equivalents, per kg dry mass).

In the light of this it was determined that the basal diet of sheep, consisting of lucerne hay, can be altered by replacing up to one half (50%) of the lucerne hay with grape seeds and husks.

Grape seeds and husks of Merlot, Shiraz, Carignan, Cabernet Sauvignon were dried, pooled in equal amounts by weight, mixed and pelleted. The basal diet, pelleted lucerne hay, was then supplemented for test purposes with the grape seeds and husks such that the latter contributed 0, 12.5, 25.0, 37.5 and 50.0% of the total dry matter intake.

Twenty Dohne merino ram lambs (41.4±2.3 kg) were used in a voluntary intake and digestion trail. A completely randomized design was used and the animals were assigned to five diets consisting of 0, 12.5, 25.0, 37.5 and 50% grape seeds and husks.

The chemical composition of the five diets, and the grape seeds and husks, before being fed to the animals, is listed in Table 3 (see page 15). The protein content decreased as the percentage grape seeds and husks increased in the diet, while the CP-ADF (protein attached to cell walls, and therefore indigestible) increased. The level of condensed tannin increased dramatically as the percentage grape seeds and husks increased in the diets. The condensed tannins are reported to bind to proteins and sometimes may reduce the protein digestibility (Walton et al., 2001).

All the animals were vaccinated and drenched before the experiments, and were kept in individual pens. Feeding was ad lib and at a level close to maintenance (40-45 g DM kg⁻¹LW^{0.75} per day), as recommended by Van Es and Van der Meer (1980). During the trail, which lasted 35 days (14 days for acclimatization and 21 days for the experiment), daily water and dry matter intake were measured. Faeces were collected daily from each animal, dried at 50° C. for 96 h, and ground through a 1 mm screen.

The fecal, orts and feed samples were analyzed for dry matter (DM), ash, crude protein (CP) and ether extract (EE) according to AOAC (1984) methods. To determine neutral detergent fiber (NDF) and acid detergent fiber (ADF) the methods proposed by Van Soest et al. (1991) were followed. Acid-detergent insoluble nitrogen (ADIN) was measured (Licitra et al., 1996), and the results reported as crude protein (ADF-CP). The sorghum tannin equivalent method was used for determination of condensed tannins.

Blood samples (10 ml) were taken from each sheep at the end of the digestibility trial. Blood was taken from the jugular vein into heparinized tubes and centrifuged for 20 min at 3 000 rpm (revolutions per minute) to separate the plasma, which was stored at −20° C. The plasma was analyzed according to normal procedures used for diagnosing domestic animal hepatic and kidney damage and general disorders (Kaneko, 1989). Components measured were total protein, plasma urea nitrogen and creatinine. In addition, the plasma enzymes aspartate aminotransferase (AST) and gamma glutamyltranspeptidase (GGT) were measured.

The average feed intake, water intake and blood metabolic profile data are listed in Table 4 (see page 16).

According to Table 4 the voluntary feed and water intake were not significantly influenced (P≧0.05) by the percentage grape seeds and husks included in the diet. The final body weight was also not negatively influenced (P≧0.05) by the inclusion of grape seeds (pips) and husks up to 50% of the diet. The presence of tannin in a forage has been assumed to affect voluntary intake (McLeod, 1974). However, in this trial intake problems were not observed with inclusion levels of up to 50% of diet dry matter.

There were no differences between diets in any plasma metabolite, except for blood urea nitrogen (Table 4). An increase of creatinine can be related with renal failure, but the level found in the present study fell within the normal range for sheep (Kaneko, 1989). No significant changes in plasma enzymes AST and GGT were found. These enzymes are used to detect if tannin-related hepatotoxicity occurred (Zhu & Filippish, 1992). In sheep fed with lucerne hay, the blood urea nitrogen concentration was higher (P≦0.05) than in sheep fed with the diets including the grape seeds and husks, which is directly related to the limitation in protein digestibility in sheep fed husks and pips. Similar results were found by Silanikove et al. (1996) where urea concentration was higher in goats fed with tannin-rich leaves than when fed wheat straw.

The digestibility of the five diets is shown in Table 5 (see page 16).

According to this data, grape seeds and husks could be considered low quality roughage. The digestibility of the crude protein, neutral detergent fiber and acid detergent fiber decreased significantly, while the dry matter digestibility showed a strong tendency towards a lower digestibility as the percentage grape seeds and husks increased in the diet. This result may be due to several factors. Firstly, the husks and pips had a much higher level of CP-ADF (crude protein bound to the indigestible fiber fraction) than that of lucerne hay (71.5% vs. 17.6% of the total protein is bound to the fiber). Secondly, it could be due to the presence of condensed tannins in husks and pips. The condensed tannin content of the husks and pips was 20 times higher than that of lucerne hay. These compounds may form complexes with proteins and carbohydrates (Makkar et al., 1996), decreasing the available protein and energy for rumen microorganisms.

The decrease in diet digestibility as the percentage husks and pips included in the diet increased, might be due to factors such as high levels of proteins bound to the acid detergent fiber and condensed tannins. However, sheep accepted an inclusion up to 50% in the diet and toxic effects were not evident in this study.

It is therefore not exactly clear as to whether or not the effects of the tannins will adversely affect the mixed feed according to the invention but, nevertheless, an attempt was made to diminish these effects utilizing tannin-hydrolysing lactic acid bacteria.

Isolation of Tannin Hydrolysing Strains:

Tannin-hydrolysing lactic acid bacteria were isolated from the faeces of goats and sheep. Fecal samples were streaked onto MRS Agar (Merck) plates, incubated for 3-5 days at 37° C., and colonies of various morphology selected. A total of 200 isolates were collected and tested for tannin hydrolysis as follows:

BHI (Brain Heart Infusion) Agar (Merck), supplemented with 0.5% yeast extract (Unilab), was overlaid with 5 ml of a 2% (w/v) tannic acid (Unilab, 5944000) solution and left at room temperature (approx. 25° C.) for at least one hour. The excess tannic acid solution was then decanted and rinsed from the plates by using sterile distilled water. The plates were left to dry and then inoculated with 100 μl of an active growing culture from BHI broth. The plates were incubated at 37° C. for at least 24 h.

From the above plates, six colonies tested positive for the degradation of tannic acid (observed as clearing zones surrounding the colonies). Pure cultures were obtained by repeated streaking onto BHI Agar and stores at −80° C. in 40% (v/v) glycerol. Four strains with the highest tannin hydrolysis activity, based on the reactions recorded on the BHI Agar plates, were selected.

Identification and Characteristics of the Strains:

Identification was done by using the API 50CHL carbohydrate fermentation profile test system. Two of the strains were identified as Streptococcus spp. and two as Lactobacillus spp. The strains were numbered TS1 and TS2 (streptococci) and TL1 and TL2 (lactobacilli).

Characteristics of the Strains:

Gram-positive, catalase negative. Cocci in chains (streptococci) or elongated cells (lactobacilli).
None of the strains could utilize tannic acid as a sole carbon source.
L-lactic acid is produced from the fermentation of glucose.
Gucose, starch, cellobiose, gallactose, mannose, trehalose, sucrose, lactose, fructose, maltose, raffinose and inulin are fermented. Rhamnose, glycerol, xylose, sorbitol, inositol and arabinose are not fermented.
Optimal growth at 37° C.
Good growth in the absence of CO₂.
Growth in MRS broth, but prefers BHI broth.
   Treatment of the Grape Seeds and Husks:

The dried grape seeds and husks were milled in a hammer mill to a particle size of 1 mm in diameter. Three parts of sterile distilled water were added to one part of the milled grape seeds. Peptone (2%, w/w) was added to the grape seed suspension and then heat-treated for 2 min at 100° C. The heated suspension was left to cool down to room temperature (approx. 25° C.). One of the batches was inoculated with 10% (v/v) of an equal combination of strains TS1, TS2, TL1 and TL2. The other batch was inoculated with a control Lactobacillus sp. that could grow in the suspension, but tested slight positive for tannin hydrolysis.

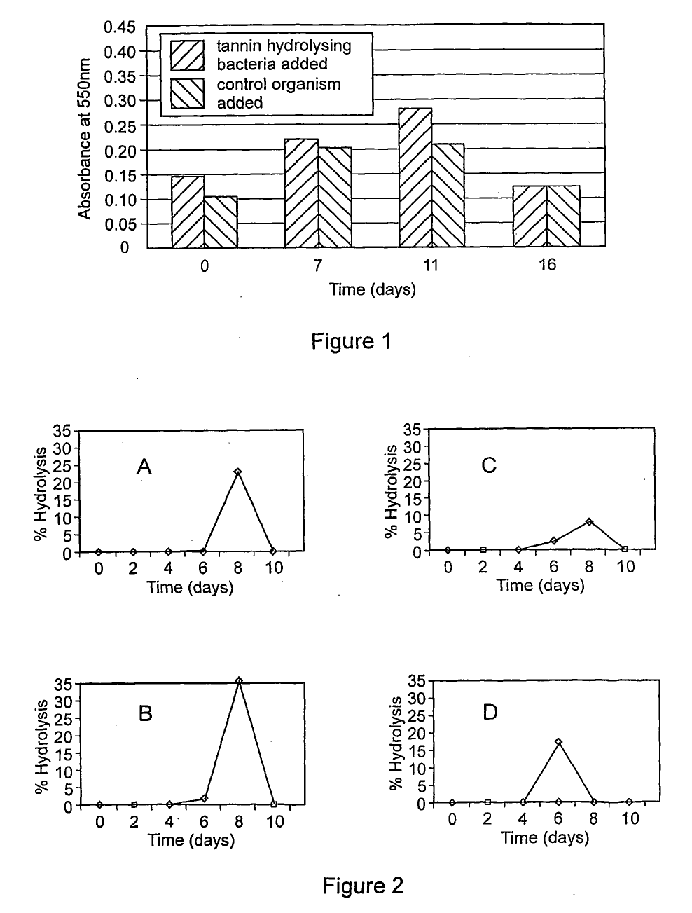

Treatment of the grape seed (pip) and husk suspension with tannin-hydrolyzing bacteria resulted in the hydrolysis (“splitting”) of tannins from the protein (peptone added to the suspension). A clear increase in free tannins, as determined with a standard acid butanol and spectrophotometric assay, was recorded in the batch treated with the tannin-hydrolyzing bacteria (FIG. 1). The highest level of free tannins (OD=0.2835) was recorded after 11 days of treatment with the tannin-hydrolyzing bacteria. The control batch revealed much lower hydrolytic activity (FIG. 1).

Binding of tannins to proteins can be decreased by treating the grape seeds and husks beforehand with a combination of tannin-hydrolyzing lactic acid bacteria (TS1, TS2, TL1 and TL2).

In a repeat of the above study, but with the four strains used separately, the hydrolysis of tannins in a tannin-rich medium was detected over a period of 10 days by using the acid-butanol assay. FIG. 2 indicates the percentage hydrolysis by each of the lactic acid bacteria. Of all the strains, Streptococcus ST1 (FIG. 2A) and Streptococcus ST2 (FIG. 2B) had the highest degree of tannin hydrolysis (approx. 25 and 35%, respectively). Lactobacillus strains LT1 (FIG. 2C), LT2 (FIG. 2D) also had the ability to hydrolise tannins, but to a lesser extent (approx. 10 and 20%, respectively). As indicated in FIG. 2, maximal tannin hydrolysis occurred at day 8 (day 6 for LT2), followed by a decrease in the percentage hydrolysis.

In vitro tests are currently being done to determine the digestibility of the treated grape seed (pip) and husk suspension. The method described by Tilley et al. (1963) will be used.

Strains TS1, TS2, TL1 and TL2 may be cultured in 10% (v/v) molasses (pH 7.0) for 24 h before treating of the grape seeds, husks and pips as mentioned above.

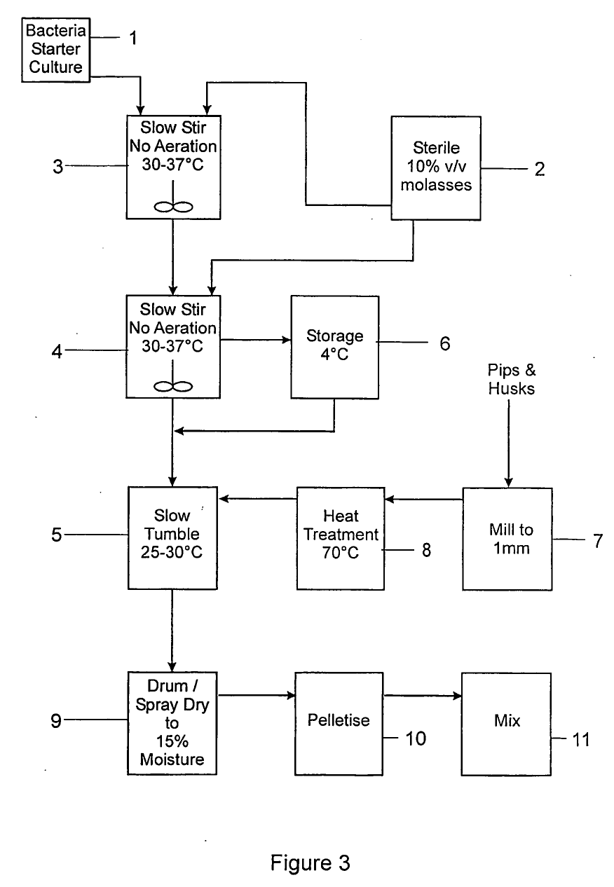

As shown in FIG. 3, a proposed process for the pretreatment of grape pips and husks to be used according to the invention could involve the addition of say 10 litres of a suspension of the mixed culture that is stored at 4° C. in a 10% v/v molasses solution in a storage container (1) to 90 litres of a sterile 10% v/v molasses solution that has been sterilised typically by boiling for 15 minutes that is supplied from a storage container (2). The mixture is fermented in a fermentation vessel (3) for 24 hours at a temperature of 30-37° C. Fermentation is carried out without aeration and with slow stirring. 90 litres of the resultant suspension is then added to 910 litres of the sterile molasses solution in a further fermentation vessel (4) and fermentation takes place as indicated above. Part or all of the resultant suspension can then be added to pre-treated, milled grape seed and husk at the rate of three parts of suspension to one part of milled grape seed and husk in a suitable tumble type of apparatus (5) in which it is tumble slowly at a temperature of 25 to 30° C. without aeration. Any balance of this suspension be stored in a storage tank (6) at 4° C.

The pre-treated, milled grape seed and husk, is preferably passed through a hammer mill (7) to a particle size of 1 mm in diameter and heat treated at 70° C. for 30 minutes in a suitable kiln (8).

The thoroughly mixed, is then drum or spray dried as indicated by numeral (9) to a moisture content of about 15 percent preparatory to pelletising as indicated by numeral (10) and subsequent mixing with the conventional grass based feed as indicated at (11).

Probiotic Properties:

Antimicrobial Resistance.

Grazing animals are usually treated with the antibiotics ampicillin, chloramphenicol, neomycin, furazolidone, streptomycin, tetracycline, kanamycin, nalidixic acid, gentamycin, ciprofloxacin, sulphonamides, erythromycin, and oxacilin to prevent infectious diseases caused by the pathogens Escherichia coli, Salmonella, Staphylococcus aureas, Campylobacter and enterococci (Barton, Pratt and Hart, 2003). Strains TS1, TS2, TL1 and TL2 were resistant to most of the antibiotics tested (Table 6 (see page 17)). However, the antibiotics erythromycin, tetracycline, novobiocin, ampicillin and chloramphenicol resulted in total growth inhibition.

Growth at Different pH Values.

To determine if the lactic acid bacteria were able to function as a probiotic in grazing animals, their growth was tested at different pH values. All the strains were able to grow between pH 5 and 8 in BHI broth. The best growth was obtained between pH 7 and 8. Initial medium pH of 4 and below completely inhibited growth of the four strains.

Resistance to Bile Salts.

Strains TS1, TS2, TL1 and TL2 grew in the presence of 9% (w/v) bile salt, but with an increase in lag phase. This indicated that the bacteria do have the ability to adapt to high bile salt concentrations as would be found in the intestine of most grazing animals.

Attachment to Intestinal Cells.

Bacligh™ studies were done to determine if the four bacteria would be able to attach to intestinal cells. Streptococcus strains TS1 and TS2 attached to the mucus layer of porcine ileum, whereas strains TL1 and TL2 were unable to do so, or attached only slightly. Attachment to mucus increases the possibility of the cells becoming colonized in the intestine.

Whilst it is not yet clear as to the long-term effects of utilizing grape seeds and husks that has not been treated to relieve the effects of the high tannin content as a part of an animal feed typically containing as the other part lucerne hay it is expected that the treated great seeds and husks will in any event be highly useful as a part of such feed and will put to good use an agricultural byproduct that does not find any particular present use.

Tables:

TABLE 1
Chemical composition of unpressed and pressed grape seeds (pips)

| Chemical component (%) | Grape pips | Husks and pips | Alfalfa |
|---|---|---|---|
| ADF | 52.4 | 40.8 | 35 |
| NDF | 58.2 | 42.7 | 38.5 |
| DM | 90.8 | 94 | 89 |
| ASH | 2.3 | — | 7.9 |
| Protein | 8.2 | 12.7 | 15 |
| Fat | 10.3 | 7.9 | 1.6 |
| Fiber | 35.7 | 21.9 | 28 |

TABLE 2
Amino acid content (%) of the grape seeds (pips)

| Amino acid | Grape pips | Maize | Soya |
|---|---|---|---|
| Amino Acid Rec | 8.656 | | |
| Aspartic acid | 0.758 | | |
| Threonine | 0.225 | 2.13 | 1.82 |
| Serine | 0.365 | | |
| Glutamic acid | 2.040 | | |
| Proline | 0.564 | | |
| Glycine | 0.840 | | |
| Alanine | 0.360 | | |
| Valine | 0.415 | 1 | 2.36 |
| Methionine | 0.034 | 1.51 | 0.63 |
| Isoleucine | 0.355 | 2.72 | 2.28 |
| Leucine | 0.565 | 10.38 | 3.55 |
| Tyrosine | 0.181 | | |
| Pheynylalanine | 0.337 | 3.94 | 2.36 |
| Histidine | 0.226 | 1.3 | 1.23 |
| Lysine | 0.387 | 1.07 | 2.89 |
| Arginine | 0.546 | 2 | 3.45 |
| Ammonia | 0.680 | | |

TABLE 3
Physical (on an air dry basis) composition (%) and chemical (on
a dry matter basis) composition (%) of the experimental diets

| | | | | | | Grape pips |
|---|---|---|---|---|---|---|
| Experimental diet | 1 | 2 | 3 | 4 | 5 | & husks |
| Lucerne hay | 100 | 87.5 | 75.0 | 62.5 | 50 | |
| Grape pips and husks | 0 | 12.5 | 25.0 | 37.5 | 50 | |
| Chemical composition | | | | | | |
| Dry matter | 92.5 | 92.1 | 92.0 | 92.0 | 92.4 | 92.3 |
| Organic matter | 88.9 | 89.4 | 89.1 | 90.7 | 92.0 | 92.9 |
| Ash | 11.1 | 10.6 | 10.9 | 9.3 | 8.0 | 7.1 |
| Crude protein | 18.2 | 17.9 | 17.2 | 16.2 | 15.1 | 13.7 |
| Neutral detergent fibre | 44.0 | 43.4 | 43.8 | 43.9 | 43.6 | 43.3 |
| Acid detergent fibre | 33.4 | 34.5 | 36.3 | 37.0 | 38.5 | 43.4 |
| CP-ADF (g/100 g CP¹) | 3.2 | 4.3 | 4.8 | 5.7 | 5.5 | 9.8 |
| Ether extract (fat) | 2.4 | 3.4 | 4.6 | 6.9 | 7.2 | 11.0 |
| Total condensed tannins, | 0.7 | 2.4 | 4.1 | 5.7 | 7.4 | 14.1 |
| gSTE²/kg DM | | | | | | |

¹CP = Crude protein
²STE = Sorghum Tannin Equivalents

TABLE 4
Average feed, water intake and blood metabolic profile of sheep fed the different diets

| | Lucerne hay:Grape seeds (pips) and husks | | | | | | |
|---|---|---|---|---|---|---|---|
| Item | 100:0 | 87.5:12.5 | 75:25 | 62.5:37.5 | 50:50 | SEM | P |
| Initial body weight, kg | 41.7 | 41.4 | 41.4 | 41.5 | 40.8 | 2.25 | 0.99 |
| Final body weight, kg | 45.0 | 44.6 | 43.3 | 43.8 | 41.5 | 2.40 | 0.85 |
| DM intake, g/day | 1840 | 1916 | 1881 | 1943 | 1952 | 148.5 | 0.98 |
| DM intake/W^{0.75}, g/day | 110 | 116 | 114 | 117 | 119 | 7.08 | 0.94 |
| Water intake, l/day | 7.74 | 7.49 | 7.67 | 6.84 | 6.19 | 0.77 | 0.58 |
| Water intake/W⁰⁷⁵, l/day | | | | | | | 0.46 |
| Blood urea nitrogen, | 9.6^{a} | 7.4^{b} | 7.5^{b} | 6.4^{b} | 6.7^{b} | 0.73 | 0.05 |
| mg/100 ml | | | | | | | |
| Total protein, mg/100 ml | 68.0 | 67.5 | 69.8 | 71.3 | 68.3 | 2.36 | 0.79 |
| Creatinine, mg/100 ml | 118.8 | 122.0 | 119.3 | 125.3 | 124.8 | 5.50 | 0.87 |
| AST, units/l | 75.8 | 93.3 | 73.5 | 80.5 | 89.8 | 6.25 | 0.25 |
| GGT, units/l | 80.5 | 70.0 | 72.0 | 76.0 | 68.5 | 4.26 | 0.31 |

^{a,b,c}Values in rows bearing different superscript letters shows significant (P ≦ 0.05) differences
SEM = standard error of the mean;
P = probability

TABLE 5
Apparent digestion coefficients of the diets

| | Lucerne hay:Grape seeds (pips) and husks | | | | | | |
|---|---|---|---|---|---|---|---|
| Item | 100:0 | 87.5:12.5 | 75:25 | 62.5:37.5 | 50:50 | SEM | P |
| Apparent digestibility (%) | | | | | | | |
| Dry matter | 57.1 | 53.9 | 50.4 | 46.8 | 48.0 | 2.45 | 0.053 |
| Crude protein | 68.4^{a} | 64.2^{ab} | 59.0^{b} | 56.3^{bc} | 52.5^{c} | 1.91 | 0.0002 |
| Neutral detergent fibre | 42.6^{a} | 33.5^{b} | 32.3^{b} | 23.9^{c} | 18.5^{c} | 2.12 | <0.0001 |
| Acid detergent fibre | 39.9^{a} | 26.4^{b} | 23.7^{b}c | 17.1^{cd} | 12.8^{d} | 3.21 | 0.0003 |
| Ether extract (fat) | 39.3^{a} | 66.1^{b} | 77.7^{c} | 82.6^{c} | 79.0^{c} | 3.82 | <0.0001 |

^{a,b,c}Values in rows bearing different superscript letters shows significant (P ≦ 0.05) differences
SEM = standard error of the mean;
P = probability

TABLE 6
Antibiotic resistance of the our lactic acid bacteria

| Antibiotics | TS1 | TS2 | LT1 | LT2 |
|---|---|---|---|---|
| Amikacin (30 μg/disc) | C | C | C | C |
| Ampicillin (10 μg/disc) | A | A | A | A |
| Bacitracin (10 units/disc) | C | C | C | C |
| Cefepime (30 μg/disc) | C | C | C | C |
| Ceftriaxone (30 μg/disc) | C | C | C | C |
| Ceftazidime (30 μg/disc) | C | C | C | C |
| Cephazolin (30 μg/disc) | C | C | C | C |
| Cefotaxine (30 μg/disc) | C | C | C | C |
| Cefuraxime (30 μg/disc) | C | C | C | C |
| Chloramphenicol (30 μg/disc) | A | A | A | A |
| Ciprofloxacin (5 μg/disc) | B | B | B | B |
| Compound Sulphonamides (300 μg/disc) | C | C | C | C |
| Colistin sulphate (25 μg/disc) | C | C | C | C |
| Cloxacillin (5 μg/disc) | C | C | C | C |
| Clindamycin (10 μg/disc) | C | C | C | C |
| Erythromycin (15 μg/disc) | A | A | A | A |
| Fusidic acid (5 μg/disc) | B | B | A | A |
| Furazolidone (50 μg/disc) | C | C | C | C |
| Gentamicin (10 μg/disc) | C | C | C | C |
| Kanamycin (30 μg/disc) | C | C | C | C |
| Metronidazole (5 μg/disc) | C | C | C | C |
| Methicillin (5 μg/disc) | C | C | C | C |
| Neomycin (30 μg/disc) | C | C | C | C |
| Novobiocin (5 μg/disc) | A | A | A | A |
| Nitrofurantoin (300 μg/disc) | B | B | B | B |
| Nystatin (100 units/disc) | C | C | C | C |
| Nalidixic acid (30 μg/disc) | C | C | C | C |
| Oflaxacin (5 μg/disc) | B | B | B | B |
| Oxacillin (1 μg/disc) | C | C | C | C |
| PolymyxinB (300 units/disc) | C | C | C | C |
| Rifampicin (5 μg/disc) | B | B | B | B |
| Sulphamethoxazole (100 μg/disc) | C | C | C | C |
| Streptomycin (10 μg/disc) | C | C | C | C |
| Tetracyclin (30 μg/disc) | A | A | A | A |
| Tobramycin (10 μg/disc) | C | C | C | C |

Diameter of inhibition zones: 17 mm and more (A), between 12 and 16 mm (B), no zones to 11 mm in diameter (C).

### REFERENCES

Aitchison, E., 1988. Cereal straw and stubble as sheep feed. J. Agric. W. Aust. 29: 96-101.
AOAC, 1984. Official Methods and Analysis, 15^{th} Edition. Association of Official Analytical Chemists, Washington, D.C., pp. 1141.
Australian Centre for International Agricultural Research.
Barton, M. D., Pratt, R., and Hart, W. S. 2003. Antimicrobial resistance in animals. Communicable diseases Australia. Australian Government Department of Health and Ageing.
Brand, T. S., Franck, F., Durand, A. & Coetzee, J., 1997. Use of varying combinations of energy and protein sources as supplementary feed for lambing ewes grazing cereal stubble. Aust. J. Exp. Agric. 37: 1-9.
Brooker, J. D. 2000. International Workshop on Tannins in Livestock and Human Nutrition.
http://www.aciar.gov.au/publications/proceedings/92/index.htm
Brooker, J. D., 1994 Streptococcus caprinus sp.nov. a tannin-resistant ruminal bacterium from feral goats. Letts. Appl. Microbiol. 18:313-318.
Butler, L. G., 1989. Sorghum polyphenols. In: Cheeke, P. R. (Ed.), Toxicants of Plant Origin, Vol. 4. Phenolics, CRC Press, Boca Raton, Fla., pp. 95-114.
Dann, P. R. & Coombe, J. B., 1987. Utilization of fodder crops and crop residues. In: Temperate Pastures, their production, use and management. Eds. Wheeler, L. W., Pearson, C. G. and Robards, G. E., Australian Wool Corporation, Australia, p. 517-525.
Flores, M. P., Castanon, J. I. L. & Mcnab, J. M., 1994. Effect of tannins on starch digestibility and TMEn of triticale and semi-purified starches from triticale and field beans. Br. Poult. Sci. 35: 281-286.
Kaneko, J. J., 1989. Clinical Biochemistry of Domestic Animals, 4^{th} Edition. Academic Press, New York, pp. 932.
Licitra, G., Hernández, T. M. & Van Soest, P. J., 1996. Standardization of procedures for nitrogen fractionation of ruminal feeds. Anim. Feed Sci. Technol. 57: 347-358.
Makkar, H. P. S., Goodchild, A. V. & Abd El-Moneim, A. M., 1996. Cell-constituents, tanning levels by chemical biological assays and nutritional value of some legume foliage and straws. Sci. Food Agric. 71: 129-136.
McLeod, M. N., 1974. Plant tannins—their role in forage quality. Nutr. Abst. Rev. 44: 803-815.
McSweeny, C. S. 1998. Isolation and characterisation of proteolytic ruminal bacteria from sheep and goats fed the tannin-containing shrub legume Calliandra calothyrsus. Appl. Environ. Microbiol. 65: 3075-3083.
Nelson, K. E. 1995. Isolation and characterisation of an anaerobic ruminal bacterium capable of degrading hydrolysable tannins. Appl. Environ. Microbiol. 61:3293-3298.
Odenyo, A. A., Osuji, P. O. 1998. Tannin-tolerant ruminal bacteria from East African ruminants. Can. J. Microbiol. 44:905-909.
Osawa, R. 1990. Formation of a clear zone on tannin-treated brain heart infusion agar by a Streptococcus sp. isolated from faeces of koalas. Appl. Environ. Microbiol. 56:829-831.
Osawa, R., Fujisawa, T., Sly, L. I. 1995. Streptococcus gallolyticus sp. nov., gallate-degrading organisms formerly assigned to Streptococcus bovis. Syst. Appl. Microbiol. 18:74-78.
Osawa, R., Sly, L. I. 1992. Occurrence of tannin-protein complex degrading Streptococcus sp. in faeces of various animals. Syst. Appl. Microbiol. 15:144-147.
Silanikove, N., Gilboa, N., Perevolotsky, A. & Nisan, Z., 1996. Goats fed tannin-containing leaves do not exhibit toxic syndromes. Small Rumin. Res. 21: pp. 195-201.
Sly, L. I., Cahill, M. M., Osawa, R., Fujisawa, T. 1997. The tannin-degrading species Streptococcus gallolyticus and Streptococcus caprinus are subjective synonyms. Int. J. Syst. Bacteriol. 47:893-894.
Tangendjaja,-B. 2000. Tannins and Ruminant Production in Indonesia. Australian Centre for International Agricultural Research.
http://www.aciar.gov.au/publications/proceedings/92/index.htm
Tilley. J. M. A. & Terry, R. A., 1963. A two-stage technique for the in vitro digestion of forage crops. Br. Grassl. Soc. 18: 104-111.
Van Es, A. J. H., Van der Meer, J. M., 1980. Methods of analysis for predicting the energy and protein value of feeds for farm animals. In: Proceeding of the 31^{st} Annual Meeting, EAAP, Netherlands. Pp. 39-43.
Van Soest, P. J., Robertson, J. B. & Lewis, B. A., 1991. Methods for dietary fiber, neutral detergent fiber and nonstarch polysaccharides in relation to animal nutrition. Dairy. Sci. 74: 3583-3597.
Walton, J. P., Waghorn, G. C., Plaizer, J. C., Birtles, M. & McBride, B. W., 2001. Influence of condensed tannins on gut morphology in sheep fed Lotus peduncultus. Can. J. Anim. Sci. 81: 605-607.
Zhu, J. & Filippish, L. J., 1992. Tannic acid intoxication in sheep and mice. Res. Vet. Sci. 63:280-292.

1. A mixed animal feed comprising a conventional grass based feed admixed with at least one other animosity constituent comprising up to 60% by weight of by-product grape seed optionally mixed with grape husks.

2. A mixed animal feed as claimed in claim 1 in which the conventional grass based feed includes lucerne hay.

3. A mixed animal feed as claimed in claim 1 in which the grape seed and, where present, grape husks, have been pre-treated with at least one tannin degrading bacteria.

4. A mixed animal feed as claimed in claim 3 in which the grape seed and, where present, grape husks, have been pre-treated with a combination of tannin degrading bacteria.

5. A mixed animal feed as claimed in claim 3 in which at least one of the bacteria is a tannin-hydrolysing lactic acid bacteria.

6. A mixed animal feed as claimed in claim 3 in which the bacteria includes one or more of Streptococcus bovis, Streptococcus caprinus and Streptococcus gallolyticus.

7. A mixed animal feed as claimed in claim 3 in which pre-treatment with bacteria was effected by suspending the grape seed and, where present, grape husks in a suspension that is inoculated with the bacteria prior to drying.

8. A mixed animal feed as claimed in claim 1 in which the grape seeds and any grape husks admixed therewith have been dried, milled and pelleted for admixture with the conventional grass based feed.

9. An animal feed constituent characterised in that it comprises by-product grape seed optionally mixed with grape husks wherein the grape seeds and any husks mixed therewith have been treated with a tannin degrading bacteria.

10. An animal feed constituent as claimed in claim 9 in which the tannin degrading bacteria is at least one tannin hydrolysing bacteria.

11. An animal feed constituent as claimed in claim 9 in which the by-product grape seed and any husks mixed therewith are milled and sized, typically to a size of about 1 mm in diameter prior to contacting with an aqueous culture of the relevant bacteria.

12. An animal feed constituent as claimed in claim 9 in which the constituent is in a pelletised form.
